(19) United States
(12) Patent Application Publication
(10) Pub. No.: US 2016/0379202 A1
(43) Pub. Date: Dec. 29, 2016

(54) PROVIDING LOCATION-BASED FEEDBACK SERVICES

(71) Applicant: BumpD, Inc., Spokane, WA (US)

(72) Inventor: Brett Turner, Encinitas, CA (US)

(21) Appl. No.: 15/194,376

(22) Filed: Jun. 27, 2016

Related U.S. Application Data
(60) Provisional application No. 62/185,533, filed on Jun. 26, 2015.

(51) Int. Cl. G06Q 20/32; G06Q 30/02; H04W 4/02

(52) U.S. Cl. CPC G06Q 20/3224; H04W 4/023; G06Q 20/325; G06Q 30/0282

(57) ABSTRACT

Facilitating rendering of a digital gratuity, with or without an associated value, to a service worker by a customer. A communication device associated with a geographical area and at least one service worker can be detected by a mobile computing device associated with a customer. The mobile computing device can receive signals from the communication device. A location can be determined for the mobile computing device associated with the customer and a determination can be made as to whether a service worker is within a threshold distance from the mobile computing device of the customer. In response to determining that a service worker is within a threshold distance of the mobile communication device, a rendering of a digital gratuity by the customer to the service worker can be effectuated.

### CROSS-REFERENCE TO RELATED APPLICATION

This application claims priority to and the benefit of U.S. Provisional Patent Application No. 62/185,533, filed on Jun. 26, 2016 and titled “PROVIDING LOCATION-BASED FEEDBACK SERVICES,” the disclosure of which is incorporated by reference in its entirety.

### TECHNICAL FIELD

The subject matter described herein relates to providing location-based feedback services.

### BACKGROUND

In service industries meaningful feedback is typically provided through online reviews or feedback cards. Online reviews typically include a lot of information but they are also unwieldy for a business or a service worker to analyze. They contain a lot of text, which need to be read and deciphered. Furthermore, scoring review methods, such as those included on Yelp, Trip Advisor or other online review platforms are used by a self-selective subset of the population. Other feedback, such as handing someone a cash tip is typically not well tracked and the level of service provided by any one service worker is not captured in any manner that would lend itself to easy analysis.

### SUMMARY

In some aspects, a method and system are described to facilitate rendering of a digital gratuity, with or without an associated value, to a service worker by a customer. In other aspects a software application is described that facilitates implementation of the method on one or more computing devices. The method can include identifying, by a location based service on a first mobile computing device, a second mobile computing device associated with a service worker who renders a service. The second mobile computing device associated with the service worker can be selected for participation in a digital gratuity rendering process of a digital gratuity rendering application. The digital gratuity rendering process can be executed at least in part by both the first mobile computing device and the second mobile computing device.

The digital gratuity rendering process of the digital gratuity rendering application can be configured to exchange a digital gratuity from the first mobile computing device to the second mobile computing device. The digital gratuity can have a value that can be incremented to or decremented from a gratuity account value associated with the service worker and maintained by the digital gratuity rendering application. The gratuity account value associated with the service worker can be tracked, by the digital gratuity rendering application, based on the exchanging and the value of the digital gratuity.

In some aspects, the method can comprise determining a location of the first mobile computing device. The determination of the location of the first mobile computing device can be facilitated by a location-based service on a first mobile computing device. The location-based service of the first mobile computing device can include a receiver configured to receive one or more geo-location signals. The one or more geo-location signals can include wireless communication signals, signals transmitted by geo-location base stations, such as satellites and ground base stations, and/or other geo-location signals. The location-based service of the first mobile computing device can be based on receipt of signals from a short-range wireless communication system having a known location. The location-based service of the first mobile computing device can be based on receipt of multiple signals from longer-range wireless communication systems having a known location and triangulating those signals.

A device can be identified associated with a service worker who is associated with the determined location of the first mobile computing device. An indication of the service worker associated with the determined location can be presented on the first mobile computing device. Selection and/or entry of the service worker can be facilitated by a user of the first mobile computing device. Selection and/or entry of the service worker can select the service worker for participation in a digital gratuity rendering process. The digital gratuity rendering process can be performed by a digital gratuity rendering application executed at least in part by the first mobile computing device.

The digital gratuity rendering process of the digital gratuity rendering application can facilitate the exchange of a digital gratuity from the first mobile computing device to the service worker. The digital gratuity can have a value that can be incremented to or decremented from a gratuity account value associated with the service worker. The gratuity account value can be maintained by the digital gratuity rendering application.

The digital gratuity rendering application can facilitate creation of a digital gratuity account by a service worker through an Internet server. Location information associated with the service worker can be received from the Internet server.

In some implementations, a broker fee can be determined based upon the exchanging of the digital gratuity. The digital gratuity can be a digital expression of the customer's satisfaction with the service rendered by the service worker. The digital gratuity rendered to the service worker can be tracked by the digital gratuity rendering application.

The digital gratuity rendering application can be configured to facilitate presentation of the digital gratuity rendered by the customer on a graphical user interface associated with the service worker. The digital gratuity rendering application can be configured to facilitate presentation of the digital gratuity rendered by the customer to the service worker. The digital gratuity rendering application can be configured to facilitate presentation of one or more service worker metrics to the employer of the service worker.

In other aspects a system is described for facilitating the rendering of a digital gratuity to a service worker by a customer. The system can include a communication device associated with a geographical area and at least one service worker. A mobile computing device associated with a customer can be provided. The mobile computing device can have at least one receiver configured to receive signals associated with the communication device. The mobile computing device can have at least one programmable processor that can be configured to perform one or more operations. The operations can include determining a location of the at least one service worker relative to the mobile computing device based on the signals associated with the communication device received at the mobile device. A determination can be made as to whether the at least one service worker is within a predefined threshold distance from the mobile device. If the at least one service worker is determined to be within a predefined threshold distance from the mobile device an indication can be provided to the customer on a graphical user interface associated with the mobile computing device. Entry and/or selection can by the customer of a digital gratuity to the at least one service worker be facilitated.

Determining a location of the at least one service worker relative to the mobile computing device can include receiving, at the mobile computing device, geo-location information of the of the mobile computing device. Geo-location information of the communication device associated with the service worker can be received by the first mobile computing device associated with the customer. The relative distance between the communication device associated with the service worker and the mobile device can be determined. The relative distance can be based on the geo-location information of the mobile device and the communication device.

The predefined threshold can include being proximate to a place of business of the service worker. The predefined threshold can be based on the service worker being closer to the mobile device than other service workers.

In some variations presentation of the digital gratuities selection and/or entered by the customer to the service worker can be facilitated. The presentation can be provided on a graphical user interface associated with the service worker and/or an employer of the service worker. The digital gratuity rendering application can be configured to facilitate presentation of one or more service worker metrics to the employer of the service worker.

Variations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more variations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Data can be transmitted and/or exchanged using one or more protocols: ANT+, Bluetooth, Cellular, IEEE 802.14.5, IEEE 802.22, ISA100a, Infrared (IrDA), ISM band, Near-Field-Communication (NFC), Radio-frequency identification (RFID), 6LoWPAN, Ultra-Wide Band (UWB), Wi-Fi, Wi-Fi Direct, Wireless HART, WirlessHD, WirelessUSB, ZigBee, Z-Wave, and/or other wireless technologies and standards.

Variations of the current subject matter can provide one or more advantages. For example, providing an easy and effective way to provide gratuities to service workers based on information from location-based technology associated with the customer and/or the service worker. Feedback in the form of a digital gratuity that can include a digital gratuity of value and/or a rating is provided directly to the service worker. The service worker can identify how they perform compared to their colleagues. While current feedback services provide a rating of a business as a whole, the current subject matter can provide feedback, ratings, and reviews about individual service workers.

The current subject matter also relates to tracking gratuities and/or feedback from customers about service workers and/or the employers of service workers, thereby facilitating a demonstration of effective service workers. The current subject matter can increase the rate and quality of feedback for the service provided by service workers. The current subject can also provide a dashboard to businesses employing service providers. The dashboard can present a representation of service worker metrics. The business can use the service worker metrics to implement and/or maintain various business objectives. The current subject matter can also provide a service worker history to replace or augment a service workers resume. The service worker history can allow the service worker to provide verified experience and performance information to existing and prospective employers.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a software system solution, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed variations. In the drawings,

FIG. 1 is a process flow diagram illustrating aspects of a method having one or more features consistent with variations of the current subject matter;

FIG. 2 is a diagram illustrating aspects of a system showing features consistent with variations of the current subject matter;

FIG. 3 is a diagram illustrating aspects of a system showing features consistent with variations of the current subject matter;

FIG. 4A is a diagram of a graphical user interface facilitating selection of a service worker in a software application having one or more features consistent with variations of the current subject matter;

FIG. 4B is a diagram of a graphical user interface facilitating selection of a service worker employer or service establishment in a software application having one or more features consistent with variations of the current subject matter;

FIG. 4C is a diagram of a graphical user interface facilitating selection of a digital gratuity rendering to a service worker in a software application having one or more features consistent with variations of the current subject matter;

FIG. 4D is a diagram of a graphical user interface facilitating presentation to a user to confirm that a digital gratuity has been rendered to a service worker in a software application having one or more features consistent with variations of the current subject matter;

FIG. 4E is a diagram of a graphical user interface facilitating presentation to a user to select a monetary value to associated with the digital gratuity being rendered to a service worker in a software application having one or more features consistent with variations of the current subject matter;

FIG. 5A is a diagram of a graphical user interface facilitating presentation to a user indicating the history of digital gratuity renderings by the user rendered through a software application having one or more features consistent with variations of the current subject matter;

FIG. 5B is a diagram of a graphical user interface facilitating presentation to a user indicating the history of digital gratuity renderings by the user rendered through a software application having one or more features consistent with variations of the current subject matter;

FIG. 6A is a diagram of a graphical user interface facilitating presentation to a service worker indicating the history of digital gratuity renderings received by the service worker through a software application having one or more features consistent with variations of the current subject matter;

FIG. 6B is a diagram of a graphical user interface facilitating presentation to a service worker indicating the history of digital gratuity renderings received by the service worker through a software application having one or more features consistent with variations of the current subject matter;

FIG. 7A is a diagram of a graphical user interface facilitating presentation of service worker employer metrics in a software application having one or more features consistent with variations of the current subject matter;

FIG. 7B is a diagram of a graphical user interface facilitating presentation of service worker employer metrics in a software application having one or more features consistent with variations of the current subject matter;

FIG. 8 is a diagram of a system having one or more features consistent with one or more elements of the current subject matter; and,

FIG. 9 is a process flow diagram illustrating aspects of a method having one or more features consistent with implementations of the current subject matter.

### DETAILED DESCRIPTION

In the service industry, service providers are often provided gratuities by customers who have received a service from a service provider. This gratuity can be in the form of a review, praise, a kind word, a monetary tip, or other form of value. The presently described subject matter contemplates a software product configured to facilitate the rendering of a digital gratuity by a customer to a service provider using at least one mobile computing device. A service provider can register with the software product. When a customer is rendered a service by the service provider, the software product can facilitate rendering of a digital gratuity in the form of a review, a digital currency tip, an item of value and/or other digital gratuity. A digital currency tip may include a representation of a fiat currency (such as used with traditional online banking and in e-commerce), crypto currency, and/or other digital currency. An item of value may include points that are earned by the service provider. The service provider can cash-in those points for tangible items, travel or other valuable items/services. The software product can be configured to facilitate rendering of the digital gratuity by using the customer's mobile computing device. The software product can be configured to determine which registered service provider provided the service based on the proximity of a communication device associated with the service provider to the mobile computing device of the customer.

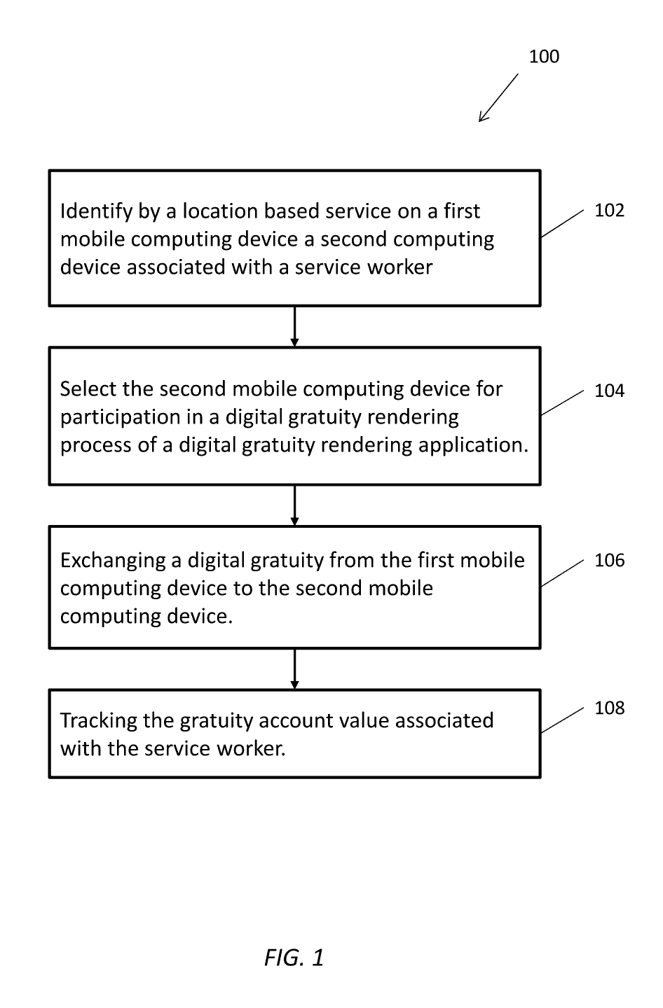

FIG. 1 is a process flow diagram 100 illustrating aspects of a method having one or more features consistent with implementations of the current subject matter. At 102 a location-based service on a first mobile computing device can be used to identify a second mobile computing device associated with a service worker. The service worker may be rendering a service. At 104, the second mobile computing device can be selected by a processor of the first mobile computing device for participation in a digital gratuity rendering process. The digital gratuity rendering process can be a feature of a digital gratuity rendering application. In some variations, the digital gratuity rendering process can be executed at least in part by both the first mobile computing device and the second mobile computing device.

FIG. 3 is an illustration 200 of one application having one or more elements consistent with the presently described subject matter. A first mobile computing device 202 can be associated with a customer 204. A second mobile computing device 206 can be associated with a service provider 208 that is providing a service to the customer 204. The service provider 208 may provide a service in an establishment, or area, where other service providers 210 are providing services. Each of the other service providers 210 can have their own second mobile computing device 212. The service providers in a given establishment, or area, can be providing services for the same organization or can be providing separate services.

The first mobile computing device 202 can be configured to facilitate exchange, by the customer, of a digital gratuity to a service provider that is/has provided a service to the customer. The first mobile computing device 202 can be configured to facilitate such a transaction based on the proximity of the first mobile computing device 202 to the second mobile computing device 206 that is associated with the service provider. The position of the second mobile computing device 206 can be determined relative to the first mobile computing device 202.

In some variations, determination of the relative positions of the first mobile computing device 202 and the second mobile computing device 206 can be performed in a closed system. The position of the second mobile computing device 206 relative to the first mobile computing device 202 can be determined based on data signals transmitted between the first mobile computing device 202 and the second mobile computing device 206. The second mobile computing device 206 can include a passive and/or active wireless communication system. The first mobile computing device 202 can be configured to detect the presence of the passive and/or active wireless communication system of the second mobile computing device 206. The first mobile computing device 202 can be configured to detect the relative distance of the second mobile computing device 206 based on the strength of signals transmitted and/or reflected by the communication system of the second mobile computing device 206.

The second mobile computing devices 212 associated with other service providers 210 may be in wireless communication with the first mobile communication device 202 and/or the second mobile communication device 206. The presence of the other second mobile computing devices 212 can facilitate determining the relative position of the first mobile communication device 202 relative to all of the second mobile communication devices 206 and 212. In some implementations, the first mobile communication device 202 can be in wireless communication with the mobile communication devices of other customers which can facilitate the determination of the location of the first mobile communication device 202. Based on determining the position of the first mobile computing device 202 relative to the second mobile communication devices 206 and 212 a determination can be made that the first mobile computing device 202 is closer to the second mobile computing device 206 than the other second mobile computing devices 212.

The presently described subject matter contemplates any form of active and/or passive wireless communication system. Such wireless communication systems can include sound-based communication systems, light-based communication systems, radio-wave-based communication systems and/or other wireless communication systems. Examples of radio-wave-based wireless communications include, but are not limited to, WiFi, Bluetooth, Near-Field Communication, sub-gigahertz, GPRS, GSM, CDMA, MMS, and/or other radio-wave-based wireless communication systems.

In some variations, determination of the relative positions of the first mobile computing device 202 and the second mobile computing device 206 can be performed in an open system. The first mobile computing device 202 and/or the second mobile computing device 206 can be in communication with a centralized server. The centralized server can be one or more computing systems configured to facilitate the exchange of a digital gratuity from a customer to a service provider. The first mobile computing device 202 can include a transceiver configured to transmit and/or receive signals to facilitate communication with the centralized server over a network. Such a network may include the Internet. Similarly, the second mobile computing device 206 can include wireless communication technology to communicate with the server over a network. Communications between the server and the second mobile computing device 206 can be facilitated over a network. In some variations, the various second mobile computing devices 206 and 212 in a common area may be connected to a local network which is, in turn, connected to a network, such as the Internet. In some variations, the network communicated over by the first mobile computing device 202 can be the local network.

Determination of the relative position of the first mobile computing device 202 and/or the second mobile computing device 206 can be facilitated by geo-location technology. For example, the first mobile computing device 202 and/or the second mobile computing device 206 can be configured to receive signals from one or more geo-location transmitters. Geo-location nodes may include ground-based geo-location transmitters, such as land-based beacons, and/or orbiting geo-location transmitters, such as geosynchronous satellites. The geo-location transmitters can transmit signals that include an identifier of the transmitter and a time at which the geo-location transmitter transmitted a particular signal. The first mobile communication device 202 and/or the second mobile communication device 206 can be configured to determine their location based on the geo-location signals received by using the identity of the transmitter, having a known location relative to a point on the surface of the Earth, and the transmitted time contained in the signal.

The first mobile computing device 202 and/or the second mobile communication device 206 can be configured to determine its location based on signals transmitted by one or more wireless communication transmitters having a known location. Such wireless communication transmitters may include transmitted capable of transmitting and/or receiving GPRS, GSM, WiFi, radio-wave, CDMA, sub-gigahertz, and/or other wireless communication signals. Such transmitters can be commonly referred to as base stations.

The geo-location of the first mobile computing device 202 and the second mobile communication device 206 can be independently determined. The first mobile computing device 202 in communication with the second mobile computing device 206 and/or a server in communication with the first mobile computing device 202 and the second mobile computing device 206 can be configured to determine that the second mobile computing device 206 is proximate to the first mobile computing device 202.

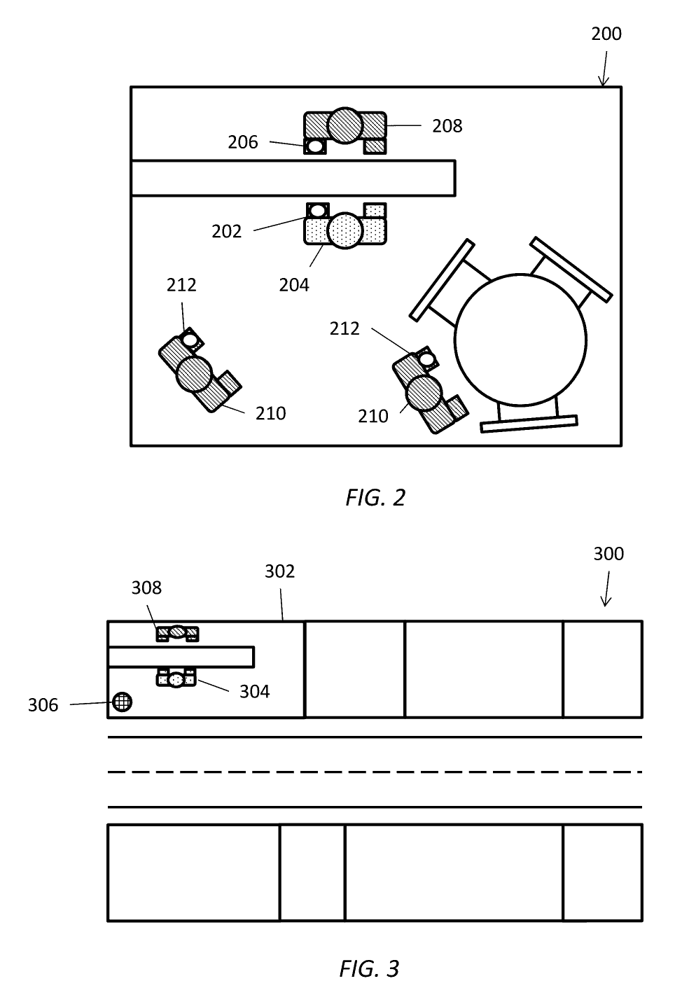

FIG. 3 is an illustration 300 of one application having one or more elements consistent with the presently described subject matter. A customer 304 may enter an area 302 at which a service is provided. The customer 304 may have a first mobile computing device 202 (as shown in FIG. 2). The area in which the customer is receiving a service from a service provider 308 may include a second computing device 306. The second computing device 306 may be a mobile or stationary computing device. The first mobile computing device 202 can be configured to detect the second computing device 306. In response to a determination by, and/or facilitated by, the first mobile computing device 202 of the second computing device 306, the first mobile computing device 202 can be configured to facilitate an exchange of a digital gratuity between the customer and the service provider.

In some variations, one or more service providers may be registered with a digital gratuity rendering application. The one or more service provides may have registered the location at which they render services. In response to a determination that the first mobile computing device 202 (as shown in FIG. 2) is within a threshold distance from the registered location of the service provider, the first mobile computing device 202 may be configured to facilitate the rendering of a digital gratuity from the customer to the service provider. The digital gratuity rendering process of the digital gratuity rendering application can be configured to facilitate the exchange of a digital gratuity from the first mobile computing device to the second mobile computing device.

In some variations, multiple service providers may be determined to be within a threshold distance from the first mobile computing device 202. Such an occurrence may occur when multiple service providers are associated with the same second mobile computing device 306 or when more than one second mobile computing device 306 associated with more than one service provider are within a threshold distance of the first mobile computing device 302. In response to such a determination, a list of the potential service providers may be presented to the customer through a graphical user interface associated with the first mobile computing device 302. The customer can enter and/or select the service provider(s) that the customer wishes to render a digital gratuity, or gratuities, to.

The first mobile computing device 202 can be a mobile phone, smart phone, laptop, tablet computer, smart watch, and/or other mobile computing device. The present disclosure contemplates the use of any computerized device and/or connected device. The second mobile computing device 206 can be a similar mobile computing device to the first mobile computing device 202. In some variations, the second mobile computing device 202 can be a mobile phone smart phone, laptop, tablet computer, smart watch, and/or other mobile computing device. Each service provider in an area can have their own mobile computing device. In other variations, the area in which the service providers are rendering a service may be associated with the second computing device. A list of service providers can be provided to the customer for selection to facilitate rendering of a digital gratuity to the service provider.

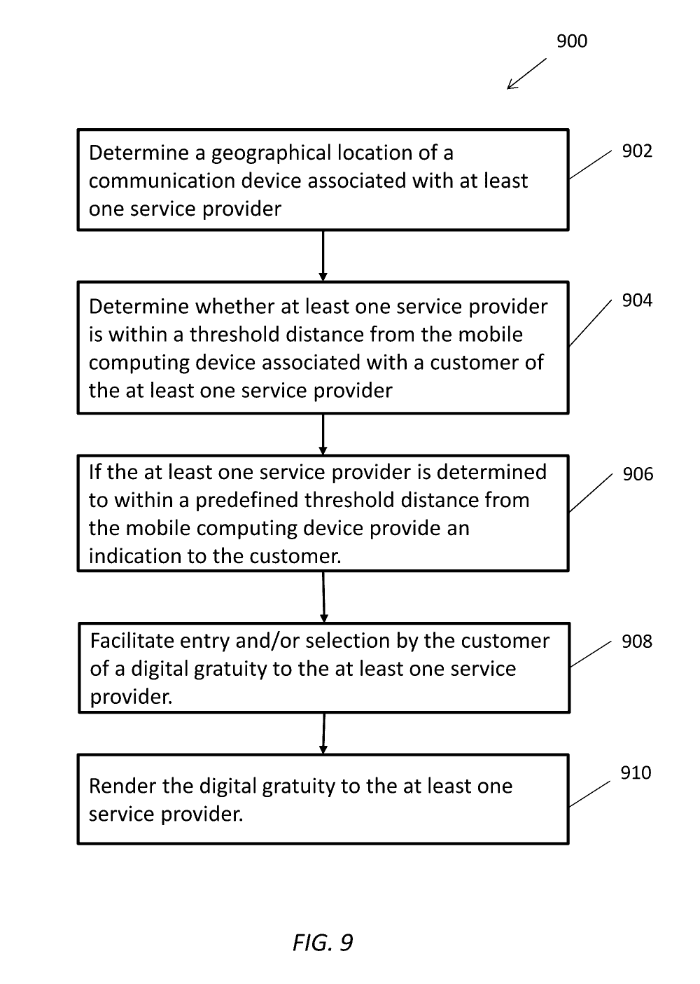

A rendering of a service can be detected. For example, the customer 204 may pay for a service using the first mobile computing device 202. During the payment process, the first mobile computing device 202 may be configured to detect the type of service provided by the service provider 208. Based on one or more of the type of service, the time of payment for the service, the location of the first mobile computing device 202, the location of the second mobile computing device 206 and/or other parameters, the first mobile communication device 202 may be configured to determine which service provider provided the service to the customer 204 and provide an offer to the customer 204 to render a digital gratuity to the service provider 208. In some implementations, payment for a service by the first mobile computing device 202 may initiate one or more of the processes described herein with respect to FIGS. 1 and 9.

In some variations, the first mobile computing device 202 can be configured to facilitate completion of a transaction between a customer 204 and a service provider 208. The first mobile computing device 202 can be in electronic communication with a transaction processor associated with the service provider 208. Identifying information associated with the service provider 208 can be provided during the transaction to a server in communication with the first mobile computing device 202 or to the first mobile computing device 202 directly. In response to receipt of the identifying information associated with the service provider 208, the digital gratuity rendering application can be configured to identify that a transaction is occurring, that it is a service provider type transaction, and, based on the identifying information associated with the service provider, identify the service provider 208 that is providing the service. In some variations, the identifying information may be associated with an employer of the service provider 208. In such variations, the first mobile computing device 202 can be configured to provide an indication of the one or more service provider personnel that work for the service provider 208, allowing the customer to select the service provider personnel who rendered the service. In other variations, the identifying information received from the transaction processor associated with the service provider can augment the location-based determination of the relative distances of the second mobile device 206 from the first mobile device 202 to increase the accuracy of the determination.

In some variations, the second mobile computing device 206 can be a badge worn by the service worker. In other variations, a badge can be worn by the service worker that is in communication with the second mobile computing device 206. The badge can include a radio-frequency transceiver, such as a radio-frequency identification device. The badge can be associated with a service worker. The badge can include one or more lights. The digital gratuity rendering process can be configured to cause the lights of the badge to activate in response to an indication that the service worker associated with the badge has received a digital gratuity. The lights can be configured to flash. An alarm or sound can be played in conjunction with the lights being activated.

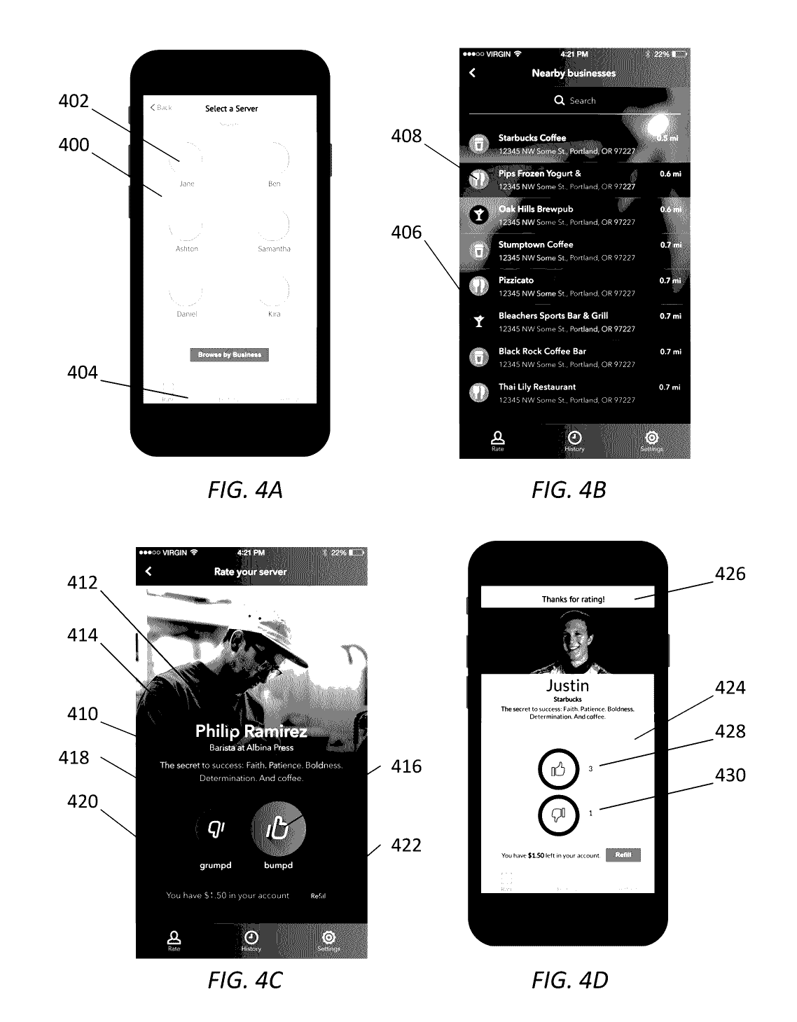

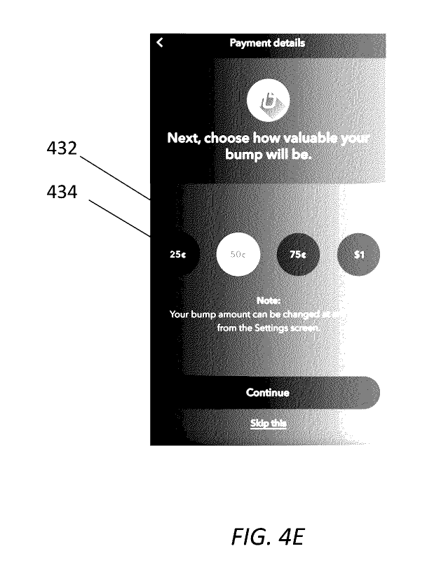

FIG. 4A is a diagram of a graphical user interface 400 presented to a customer using a system, having one or more features consistent with the currently described subject matter. The graphical user interface 400 presented to the user can include an identity 402 associated with one or more service workers within a threshold distance from the first mobile computing device. The determination of the location of the service worker(s) relative to the first mobile computing device can be based on a determination that the geographical location of the first mobile computing device corresponds to the geographical location of a service location with which the service worker(s) are associated. Service workers can associate themselves, or be associated, with a service location using the digital gratuity rendering application.

In some situations a customer can be served by multiple servers or may want to provide a digital gratuity to the service workers of a particular service provider, or service worker employer. The graphical user interface 400 can be configured to include a generic service worker for a particular service provider. In response to selection and/or entry of the generic service worker, the digital gratuity rendering application can be configured to facilitate rendering of a digital gratuity, with or without an associated value amount, to the generic service worker. The digital gratuity rendered to the generic service worker can be distributed to service workers of the service provider according to the policies of the service provider. The digital gratuity rendering application can be configured to facilitate entry and/or selection of the policies of the service provider. Such policies can include data and time restrictions, service worker type restrictions, and/or other restrictions on which service workers will participate in receipt of the digital gratuity.

In some variations, the digital gratuity rendering application can be configured to facilitate distribution of the digital gratuity received by a service worker to other employees of the service provider. For example, it can be customary for a waiter to distribute a portion of their tips to a hostess, kitchen staff, bar staff, and/or other staff in a restaurant. The digital gratuity rendering application can be configured to appropriate assign the digital gratuity to other employees of a service provider, based on predefined policies. The predefined policies can be entered and/or selected by the service worker when registering with the digital gratuity rendering application and/or by a service worker provider employing the service worker.

In some variations, the identity 402 of the service worker can be another organization. The digital gratuity rendering application can be configured to facilitate selection and/or entry of a charitable organization by the service worker(s). In response to selection and/or entry by the service worker(s) of a charitable organization, the identity 402 can be of the charity instead of the service worker(s). A customer can select and/or enter the indication of the charity and the digital gratuity rendering application can be configured to render the digital gratuity, with or without an associated value amount, to the charity. The digital gratuity rendering application can be configured to facilitate service workers to turn this functionality on or off, such that this functionality can be temporary.

The graphical user interface 400 can be configured to facilitate selection and/or entry of the identity 402 of a service worker to whom the customer intends to render a digital gratuity. The graphical user interface 400 can include one or more additional interactive regions 404 configured to facilitate providing additional functionality to the user of the first mobile computing device. The additional functionality can include providing a rating to a service worker, providing a history of digital gratuities rendered by the user, facilitating manipulation of settings associated with the digital gratuity rendering application, and/or other functionality.

In some variations, the geographical location of a second mobile computing device associated with a service worker can facilitate automatically selecting a service worker. For example, in response to determination that, at the time of service, a service worker is within a threshold distance of the first mobile computing device of the customer, he digital gratuity rendering application can be configured to cause an indication of that service worker to be presented to the customer. The threshold can be determined by a distance, a proximity to the first mobile computing device relative to all other service worker mobile computing devices and/or through other proximity related systems.

FIG. 4B is a diagram of a graphical user interface 406 presented to a customer using a system, having one or more features consistent with the currently described subject matter. The graphical user interface 406 can include an indication 408 of one or more service providers. The indication 408 of the one or more service providers can include an indication of the location, name, type and/or other information associated with the service provider. The graphical user interface 406 can be controlled by a digital gratuity rendering application. The digital gratuity rendering application can cause the graphical user interface 406 to display an indication 408 of one or more service providers in response to determining that a geographical location of the first mobile computing device on which the digital gratuity rendering application is being executed is within a threshold distance from the locations of the one or more service providers. For example, in the example illustrated by FIG. 3, a user of the first mobile computing device on which the digital gratuity rendering application is being executed can be in a service provider store 302. The determined location of the first mobile computing device can have an associated error providing a likelihood that the customer, or user of the first mobile computing device, is in one of several stores. The digital gratuity rendering application can be configured to facilitate display of each of the several stores in which the customer has a likelihood of being in on the graphical user interface 406.

The graphical user interface 406 can be configured to facilitate selection and/or entry of a service provider 408. The user of the first mobile computing device can interact with a location on the screen of the first mobile computing device corresponding to one of the one or more service providers. In response to an indication that the user has selected and/or entered one of the one or more service providers, the digital gratuity rendering application can be configured to cause the first mobile computing device to present an indication of the service workers working at that service provider location. An example of such presentation is described herein with respect to FIG. 4A.

FIG. 4C is a diagram of a graphical user interface 410 presented to a customer, in accordance with one or more variations of the presently described subject matter. The digital gratuity rendering application can be configured to present a service worker 412 to the user of the mobile computing device on which the digital gratuity rendering application is being executed. The service worker 412 can be presented to the user in response to the user interacting with graphical user interface 400, as shown in FIG. 4A, and selecting and/or entering an indication of the service worker. The graphical user interface 410 can include service worker information 414. The service worker information can include an indication of the location at which the service worker 412 is providing service. The service worker information can include a personal message from the service worker 412. The service worker information can include other information associated with the service worker 412 or the location of the service worker's employer.

The graphical user interface 410 can facilitate entry and/or selection of a rating of the service provider. The graphical user interface 410 can include a numerical rating of the service provider. The graphical user interface 410 can include a continuous rating of the service provider. The graphical user interface 410 can include a binary rating of the service provider. For example, the graphical user interface 410 can facilitate a positive rating through a positive rating indication 416. Similarly, the graphical user interface 410 can facilitate a negative rating through a negative rating indication 418. The digital gratuity rendering application can be configured to facilitate rendering of a digital gratuity in response to a user selecting and/or entering a positive rating, e.g. through positive rating indication 416. In some variations the digital gratuity can be associated with a monetary value. The monetary value can be preset by the user, such that when the user selects the positive rating indication 416 the digital gratuity having an associated preset monetary value can be rendered to the service worker.

The graphical user interface 410 can include a digital gratuity balance indication 420 representing a balance of a digital gratuity available to the user. The graphical user interface 410 can facilitate the provision of a digital gratuity by the user to the digital currency rendering application. For example, a user can provide payment details associated with an account of the user. The user can select an amount of money by which they can increase their digital currency balance. The digital currency balance can represent the amount of money provided by the user. While the digital currency balance shown in FIG. 4C is in United States dollars, this is not intending to be limiting. The digital currency balance can be provided using any currency. The digital currency balance can be provided using a virtual currency or a representation of currency.

The graphical user interface 410 can include a refill indicator 422. The user can interact with the graphical user interface 410 at the location of the refill indicator 422 to cause the digital gratuity rendering application to refill the users digital gratuity balance. The digital gratuity rendering application can be configured to refill the user's digital gratuity balance with a preset amount of digital gratuity in response to a user interacting with the refill indicator 422. In other variations, the digital gratuity rendering application can be configured to request payment information from the user. The digital gratuity rendering application can be configured to request an amount of digital gratuity to buy and/or an amount of monetary value to use to acquire an amount of digital gratuity.

FIG. 4D is a diagram of a graphical user interface 424 associated with a digital gratuity rendering application having one or more features consistent with the presently described subject matter. The graphical user interface 424 can include an indication 426 that the user has rendered a digital gratuity to the service worker. Such an indication 426 can include a message of thanks. The graphical user interface 424 can include a total positive rating indication 428. The total positive rating indication 428 can include a number of positive ratings provided by users to the service worker. Such total positive rating indication 428 can be time-limited such that it provides the number of positive ratings within a period of time. Similarly, the graphical user interface 424 can include a total negative rating indication 430.

FIG. 4E is a diagram of a graphical user interface 432 facilitating presentation to a user to select a monetary value to be associated with the digital gratuity to be rendered to a service worker in a software application having one or more features consistent with variations of the current subject matter. The digital gratuity rendering application can be configured to facilitate selection and/or entry of a value to associate with the digital gratuity rendered by the user and/or customer. Entry and/or selection can be facilitated through providing interactive electronic value buttons 434. The interactive electronic value buttons 434 can be areas on a touch screen corresponding to presentations of different value amounts. A user can interact with the portion of the touchscreen displaying a particular value amount to select and/or enter that value amount. Alternative methods can include drop-down menus, text boxes allowing a user to enter their own value, and/or other methods of providing a value amount. In some variations, the value to associate with the digital gratuity can be set as a default value such that the default value will be associated with a positive rating provided by the user to the service worker. In other variations, the value to associate with the digital gratuity can be selected and/or entered at the time of rendering the digital gratuity to a service worker. In response to a user or customer selecting to provide the service worker with a positive rating, or a digital gratuity, the digital gratuity rendering application can be configured to cause the mobile computing device of the user to facilitate selection and/or entry by the user of a value amount to associate with the digital gratuity.

In some variations, the digital gratuity can have a value that can be incremented to or decremented from a gratuity account value associated with the service worker. The gratuity account can be maintained by the digital gratuity rendering application. The digital gratuity rendering application can be configured to track the gratuity account value associated with the service worker based on the exchanging and the value of the digital gratuity.

In some variations, the digital gratuity rendering application may be configured to manage a digital gratuity balance of the customer. The digital gratuity balance of the customer can be provided by the customer. The customer may provide fiat currency to the provider of the digital gratuity rendering application. The customer may provide fiat currency using cash, check, electronic funds transfer methods, or other fiat currency transfer methods. The digital gratuity rendering application can maintain a customer balance reflective of the amount that the customer has provided. The customer balance can be reflected as fiat currency or another form of currency, such as crypto currency. The customer balance can be reflected by virtual items having a value.

The digital gratuity rendering application may be configured to manage a digital gratuity balance of the service provider. As with the customer balance, the service provider balance may be reflected as a value. Such value may be reflected as an amount of fiat currency, crypto currency, or other form of value. In some variations, the digital gratuity balance can be reflected as representations of tangible items that have been rendered to the service provider. The digital gratuity balance of the service provider can be exchanged for fiat currency or other form of currency that can be used by the service provider. In some variations, the digital gratuity rendering application can facilitate exchange of the service provider balance to an external account. The digital gratuity rendering application can be configured to facilitate the exchange in response to the amount of the service provider's digital gratuity balance exceeding a threshold level. The threshold level may be set at any level. The threshold level may be set at a level consistent with business requirements.

The digital gratuity rendering application can integrate with third-party services that provide currency exchange services. The third-party services can be configured to facilitate customers loading account balances and/or service providers cashing-out their account balances.

In some variations, the digital gratuity can include both a digital gratuity having an intrinsic value and an extrinsic value. For example, a customer may render digital currency as the digital gratuity as well as an indication of their satisfaction level of the service provided by the service provider. Such indication of the customer's satisfaction level can be represented by a score, a review, and/or other indication of satisfaction level. In some variations the digital gratuity rendered by a customer may only have an extrinsic value. The digital gratuity rendered by the customer may be a review, a score and/or other form of digital gratuity having extrinsic value.

In some variations, the digital gratuity rendering process can be configured to provide a predefined amount of a digital gratuity to a service provider. The predefined amounts can be set by the provider of the digital gratuity rendering application. The predefined amount can be based on the type of service provided. For example, if the type of service provided is serving drinks at a bar, the predefined amount may be a set value based on the number of drinks ordered. If the type of service provided is a sit-down meal, the predefined amount may be set as a percentage of the total bill for the services rendered. If the type of service is providing coffee in a coffee shop the predefined digital gratuity amounts can be provided as a set of amounts. For example, the customer can be presented with a choice of selecting one of $0.25, $0.50, $0.75 or $1.00 as the amount to tip the service worker. In response to detection of a service being rendered, either through detection of a payment, or through activation by a customer, or other user of the digital gratuity rendering application, the digital gratuity rendering application can be configured to cause a notification on the customer's mobile computing device to provide a digital gratuity.

The digital gratuity rendering application can be configured to perform the digital gratuity rendering process in response to an interaction by the customer with one interactive button on their mobile computing device. The digital gratuity rendering application can be configured to facilitate entry and/or selection of a default digital gratuity that in can include a default amount of value and/or a default rating of the service. When the customer is receiving a service from the service worker the digital gratuity rendering application can be configured to facilitate presentation of the digital gratuity-rendering button on a graphical display associated with the customer. The graphical display can be associated with a smartphone, tablet, smartwatch, and/or any mobile computing device. In response to an interaction with the digital gratuity-rendering button by the customer, the digital gratuity rendering application can be configured to execute the digital gratuity rendering process and exchange a digital gratuity having both a monetary value and a rating. In some variations, the digital gratuity rendering application can be configured to facilitate the set up of multiple interactive gratuity-rendering buttons, where each button can provide a different digital gratuity value and/or rating. The user can select one of a plurality of the predefined gratuity-rendering interactive buttons when receiving a service.

The digital gratuity rendering application can be configured to facilitate provision of a digital gratuity to both over-the-counter service workers, such as baristas, and full-service service workers, such as waiters. The digital gratuity rendering application can be configured to integrate with full-service payment systems. At the point-of-sale in a full-service setting, the customer can be given the option of providing a gratuity through the payment terminal, such as adding a tip, or through the digital gratuity rendering application. The digital gratuity rendering application can be configured to obtain a tip amount provided by the customer at the point-of-sale in a full-service setting. The digital gratuity rendering application can be configured to obtain transaction information from the transaction system associated with the service worker and/or the service worker's employer. The digital gratuity rendering application can cause one or more servers associated with the digital gratuity rendering application to obtain transaction information from one or more servers associated with the transaction system. The digital gratuity rendering application can cause one or more devices associated with the service worker and/or the servicer worker's employer to obtain transaction information from a transaction device associated with the service worker and/or service worker's employer.

The digital gratuity rendering application can be configured to facilitate distribution of the tip amount to one or more service workers of a service worker employer. The transaction information can include information associated with the transaction that includes the service workers associated with the transaction. For example, the transaction information can include one or more of the service worker assigned to a table associated with the transaction, a chef who cooked an order associated with the transaction, a barkeeper associated with the transaction, a host or hostess associated with the transaction, and/or other service workers associated with the transaction. The digital gratuity rendering application can be configured to distribute the tip received from the transaction to the one or more service workers associated with the transaction proportionally. The proportional amounts received by individual service workers can be predefined. The digital gratuity rendering application can be configured to facilitate entry and/or selection of a predefined proportion by an employer of the service workers.

In some variations, one or more mobile computing devices can be configured to, at least in part, perform part of the transaction. The digital gratuity rendering application can be configured to obtain, from the software facilitating the mobile computing device in performing at least part of the transaction, the transaction information. In other variations, the digital gratuity rendering application can be configured to perform, at least part, of the transaction. The digital gratuity rendering application can be configured to facilitate payment of the services rendered by the service worker as well as facilitate the customer providing a digital gratuity to the service worker.

The digital gratuity rendering application can be configured to receive a tip provided by the customer. At the point-of-sale in a service setting, a customer can provide an indication of an amount of gratuity they would like to provide. The digital gratuity rendering application can be configured to process the gratuity portion of the transaction, while allowing the transaction system associated with the service provider, e.g. a restaurant, handle the payment processing for the actual service. The digital gratuity rendering application can avoid the service worker employer having to collect and distribute the gratuity portion of the transaction.

In some variations, a coordinator of a dinner can select from his or her contacts, or based on the proximity of the other diners, the group of diners to send the bill to. The digital gratuity rendering software application can facilitate splitting the bill. This can also include the tip. The digital gratuity rendering software can facilitate the sending of a notice of the amount owed by the diner to the mobile computing device of the diner.

The digital gratuity rendering application can be configured to facilitate entry and/or selection by the customer of an indication that the customer is dissatisfied with the service provided by the service provider. The digital gratuity rendering application can be configured to facilitate a donation to a charity. The digital gratuity rendering application can be configured to require a donation to charity in response to receipt of an entry and/or selection by the customer of an indication that the customer is dissatisfied with the service provided by the service provider. Such as process can have the advantage of reducing frivolous indications of dissatisfaction. The digital gratuity rendering application can facilitate selection and/or entry by the customer of a charity to receive such donations. Such a process has the advantage of turning a negative experience into a more positive experience by allowing a customer to express their dissatisfaction while also helping society.

The digital gratuity rendering application facilitates a rating of the service provider. A customer can render a digital gratuity to the service provider using the digital gratuity rendering application. The amount of the rendered digital gratuity can provide an indication of the level of satisfaction of the customer with the service provided by the service provider. Similarly, timing information can be stored that provides an indication of when the customer rendered the digital gratuity. Transaction information can be stored such as the type of service provided, the cost of the service and the time of the service. This information can be cross-referenced with the timing information and amount of the rendered digital gratuity to enhance the determination of the level of satisfaction of the customer. For example, where the cost of the service provided is relatively high compared to the amount of the rendered digital gratuity conclusions may be drawn that the customer was less satisfied than time where the converse is true.

The digital gratuity rendering application can be configured to operate at the time the service is rendered thereby incentivizing a customer to provide feedback there and then. After the customer leaves satisfied they may forget or not think to provide feedback using convention feedback systems. Further incentives can be provided. For example, the service provider can be provided a notification of who rendered a digital gratuity, thereby affording the service provider to thank the customer. Receiving praise for providing a gratuity can incentive the rendering of gratuities by customers.

The customer's digital gratuity rendering history can be stored. The customer's digital rendering history can be used to provide a relative level of satisfaction of the customer for similar services across different service providers and different times. This provides the ability to compare two service providers that provide the same or similar services. This has the benefit of normalizing the reviews and feedback provided by customers. One customer may typically score a service provider highly using existing review applications. When that customer is dissatisfied with a service they may reduce that score by a one or a few points, but the score may remain a relatively high score. Another customer may typically score a service provider relatively low and only provide a high score for exceptional service. Still, other customers may provide very high scores for good service and very low scores for dissatisfactory service without ever using the score between.

By using a customer's digital gratuity rendering history, their indicated level of satisfaction with the service provider can be normalized and a more accurate reflection of a service provider's performance can be obtained.

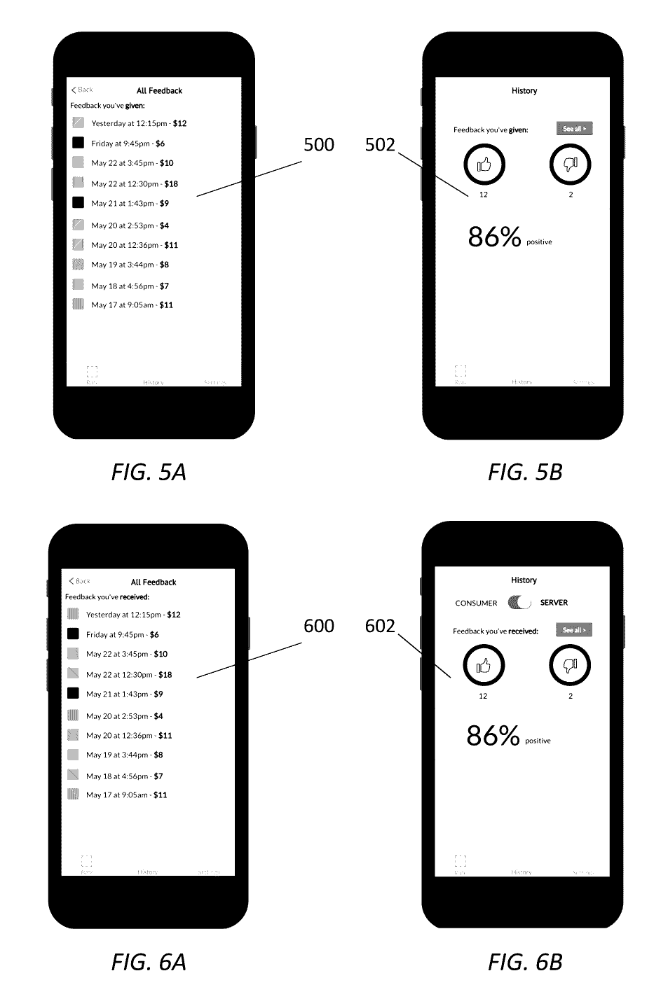

FIG. 5A is a diagram illustrating a graphical user interface 500 on a mobile computing device executing a digital gratuity rendering application having one or more features consistent with the presently described subject matter. The graphical user interface 500 can include a history of the user's digital gratuities that they have rendered to service workers. The digital gratuity rendering history of the user can include a date and time when the user rendered the digital gratuity to the service worker, an indication of the location of the service worker whom received a digital gratuity, an amount of the digital gratuity rendered, and/or other information. The indication of the location of the service worker can include a color or label indicating the identity of the service worker's employer and/or the location that the service worker provided the service.

FIG. 5B is a diagram illustrating a graphical user interface 502 on a mobile computing device executing a digital gratuity rendering application having one or more features consistent with the presently described subject matter. The graphical user interface 502 can include an indication of the number of positive ratings and/or the number of negative ratings given by the user. The graphical user interface 502 can include an indication of the percentage of positive ratings given by the user compared to the number of negative ratings. The graphical user interface 500 as shown in FIG. 5A and the graphical user interface 502 as shown in FIG. 5B can be presented to a user in response to a user.

The digital gratuity rendering application can include a history of the digital gratuities received by a service worker. FIG. 6A is a diagram illustrating a graphical user interface 600 on a mobile computing device executing a digital gratuity rendering application having one or more features consistent with the presently described subject matter. The graphical user interface 600 can include an indication of the digital gratuities rendered by customers to the service worker. The graphical user interface 600 can include an indication of the date and time when the digital gratuity was rendered, an indication as to which location the service worker received the digital gratuity, an indication of the amount of digital gratuity rendered to the service worker, and/or other information. FIG. 6B is a diagram illustrating a graphical user interface 602 on a mobile computing device executing a digital gratuity rendering application having one or more features consistent with the presently described subject matter. The graphical user interface 602 can include an indication of the number of positive ratings and/or the number of negative ratings received by the service worker. The graphical user interface 602 can include an indication of the proportion of positive ratings compared to the number of negative ratings received by the service worker. The graphical user interface 602 can include an electronic button configured to, in response to an interact by the service worker, present a graphical user interface including the digital gratuity rendering history of the service worker as a customer.

The digital gratuity rendering application can be configured to provide businesses with performance metrics of their service personnel, or individual service providers. The digital gratuity rendering application can be configured to compile the digital gratuities rendered by customers of the business to individual service personnel working for the business. The information collected by the digital gratuity rendering application can include transactional information associated with the business. This information can include the time of the transaction, the identity of the service worker, the location, the service provided and/or other information associated with the transaction.

The digital gratuity rendering application can be configured to compile a visual presentation of the performance metrics to the business executive designated to receive such information. The visual representation of the performance metrics provided by the digital gratuity rendering application can be tailored to one or more business objectives. Such information can facilitate a business in improving employee job satisfaction, implementation of worker incentive plans, maintenance worker incentive compensation programs, employee retention, training programs, and/or other programs.

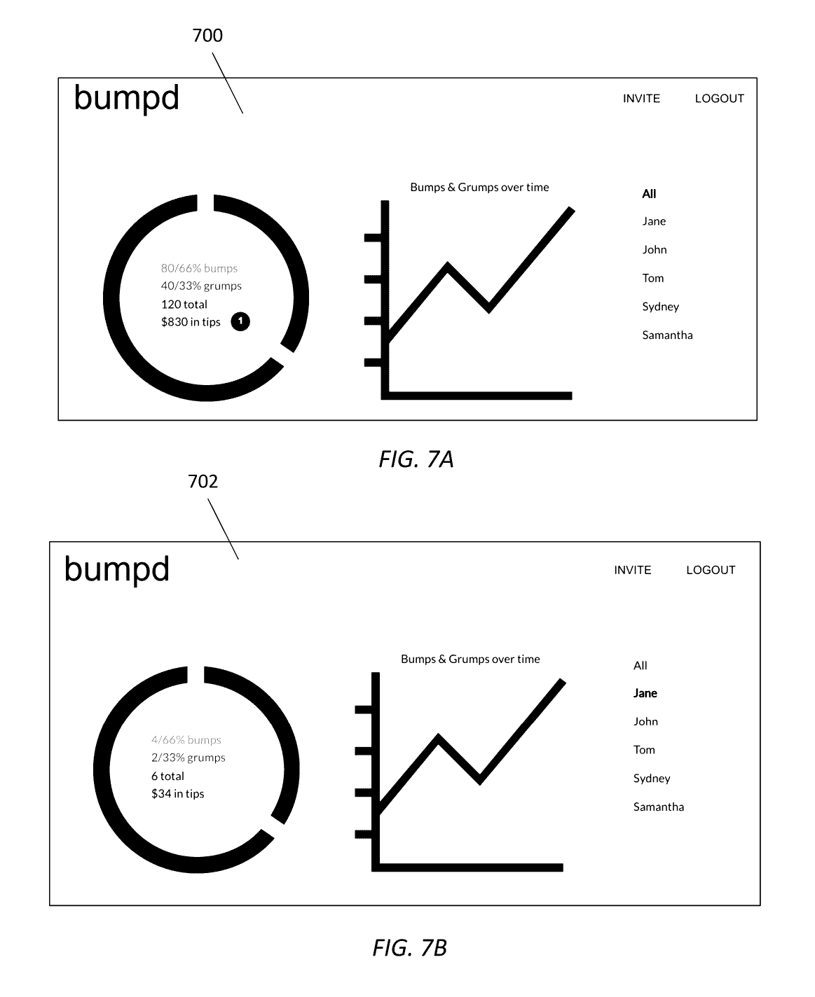

FIG. 7A is a diagram illustrating a graphical user interface 700 presented to a service worker employer. The graphical user interface 700 presented to a service worker employer can include an indication of the total number of positive ratings and/or negative ratings rendered by customers to service workers working fro the service worker employer. The graphical user interface 700 presented to a service worker employer can include a proportion of positive ratings compared to negative ratings rendered to customers to service workers working for the service worker employer. The graphical user interface 700 can include an indication of a total amount of digital gratuity rendered to service workers working for the service worker employer. The graphical user interface 700 presented to a service worker employer can include an indication of the individual service workers working for the service worker employer. The service worker employer can be provided with metrics associated with individual service workers and/or groups of service workers. The graphical user interface 700 can provide an indication of the individual service workers and/or groups. The service worker employer, or their agent, can interact with the graphical user interface to cause presentation of individual, group, and/or total metrics. FIG. 7B is a diagram illustrating a graphical user interface 702 presented to a service worker employer. The graphical user interface 702 can include metrics associated with an individual service worker.

The digital gratuity rendering application can be configured to provide digital incentives to service workers. The digital incentives can be digital badges. The digital incentives received by service workers can be visible to customers through the digital gratuity rendering application.

The digital gratuity rendering application can be configured to facilitate the entry and management of other metrics associated with the business by the business executive provided such access. Such metrics may include worker performance that cannot be determined from customers' rendering of digital gratuities, such as how well the service worker interacts with other service workers, timeliness, efficiency, cost to the business and/or other metrics. While some service workers may receive a higher than average rendering of digital gratuity from customers, those service workers may be costing the business more than other service workers, such as by being inefficient, providing discounts, higher salaries, and/or other costs to the business. The digital gratuity rendering application can be configured to facilitate determination of a cost-benefit analysis on service workers employed by the business.

The digital gratuity rendering application can be configured to compile information associated with the digital gratuity renderings of customer for each individual service worker. The digital gratuity rendering application can provide rankings of the service worker compared to other similarly-situated service workers. The digital gratuity rendering application can be configured to provide a gamified dashboard to service workers whereby their rank is provided and digital incentives and/or reward are presented. Such digital incentives and/or rewards can be visible to other service workers using the digital gratuity rendering application. Such digital incentives may be referred to as badges or tokens. By providing a gamified dashboard to service workers, the service workers can become incentivized to improve their metrics to increase their standing on service worker leaderboards and/or obtain more incentives/rewards.

The digital gratuity rendering application can be configured to facilitate incentives having an economic value. For example the digital gratuity rendering application can be configured to facilitate rewarding a service worker for having a relatively high rating compared to other service workers. The service worker can be given a reward for having the highest rating compared to other service workers. Service workers can be grouped into cohorts of service workers having similar characteristics. For example, service workers can be grouped by one or more of location, employer identity, service type, average customer tip, frequency of customer interaction and/or other characteristics. Awards and/or rewards can be given to a service worker for achieving a relative high and/or highest rating within a cohort into which they have been grouped. In some variations, the service worker is unaware of their grouping. The digital gratuity rendering application can be configured to provide a reward to customers who use the digital gratuity rendering application. For example, the provider of the digital gratuity rendering application can provide the ten thousandth customer who renders a digital gratuity on a service worker with the digital gratuity rendering application an award and/or reward. The award and/or reward could include one or more of value added to the customers account for providing digital gratuity, a digital badge, a donation to a charity, fiat currency, and/or other award and/or reward.

The digital gratuity rendering application can be configured to maintain an account of a customer. A customer can be ranked compared to other customers based on the amount that they provide a digital gratuity to the service worker. Customers can be grouped into cohorts based on characteristics of the customer. The digital gratuity rendering application can be configured to facilitate sharing of information about the customer with acquaintances of the customer registered through the digital gratuity rendering application. Providing a rank, or comparing customers, can provide an incentive to some customers to give more digital gratuities.

The digital gratuity rendering application can be configured to cause the second mobile computing device 206, or a computing device associated with the service worker, to present a notification to the service worker of a gratuity rating of the customer. Customers who provide frequent digital gratuities, or have a high incidence of providing digital gratuities relative to receiving a service can have a higher rating compared to customers who render digital gratuities less regularly. In response to a first mobile computing device 202, associated with a customer, coming within a threshold distance of a service worker, and/or within an establishment associated with the service worker, the service worker can be presented with a notification indicating the digital gratuity rendering rating of the customer. In this manner, a service worker can concentrate on providing good service to the customer who is more likely to render a digital gratuity.

Correlations can be determined between the rating a customer gives a service worker and the value of the digital gratuity they render to service workers. Correlations between value of digital gratuity and type of service rendered can be determined. A service worker can be provided an indication of whether providing a higher level of service to the customer would translate into a higher value digital gratuity being awarded. Such as system can facilitate a service worker matching the value of the digital gratuity they receive to the effort they put in servicing customers.

The digital gratuity rendering application can be configured to facilitate service worker employers in their provision of matching schemes and/or rewards. The digital gratuity rendering application can be configured to facilitate a service worker employer rewarding their highest rated employee based on the information provided through the digital gratuity rendering application.

The digital gratuity rendering application can be configured to facilitate presentation of a service workers performance metrics relative to other service workers based on varying sizes of geographic regions, service industry, business, branch, and/or other characteristics.

The digital gratuity rendering application can be configured to facilitate presentation of metrics and/or skills of a service worker to potential employers. The digital gratuity rendering application can present verifiable and reliable metrics to potential employers. The employer will no longer need to take at face value a service workers level of skill. Similarly, the digital gratuity rendering application can showcase individual service workers skills and bring those skills to the attention of employers who may be willing to pay the service worker a higher wage.

The digital gratuity rendering application can be configured to utilize a cloud-based network system. The cloud-based network system can provide ease of access to the information collected and managed by the digital gratuity rendering application. Access to information can be selectively provided based on the needs and type of the entity/individual accessing the information.

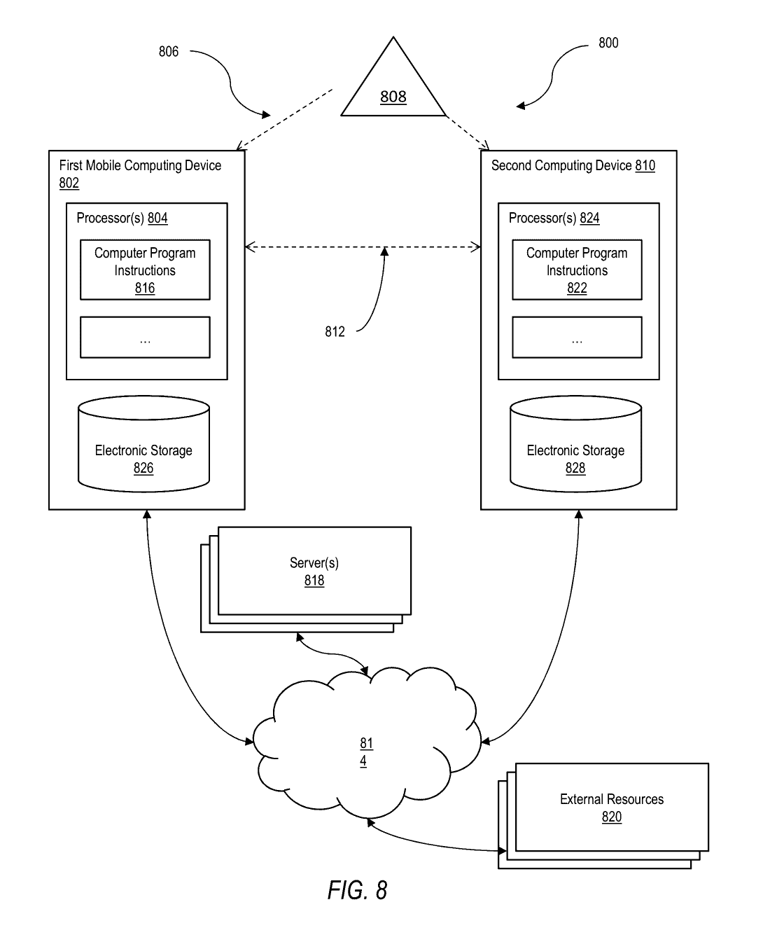

FIG. 8 is an illustration of a system 800 configured to facilitate the rendering of digital gratuities by customers to service workers, having one or more features consistent with the currently described subject matter.

A first mobile computing device 802 can be configured to execute a digital rendering software application. The digital rendering software application can include one or more machine readable instructions that when executed by a processor(s) 804 of the first mobile computing device 802, can cause the first mobile computing to perform one or more functions consistent with the described subject matter.

FIG. 9 is a process flow diagram 900 illustrating aspects of a method having one or more features consistent with variations of the current subject matter. At 902 a determination of a location of the first mobile computing device 802 can be determined. The location of the first mobile computing device 802 can be determined based on one or more signals 806 received by the first mobile computing device 802. The one or more signals 806 being transmitted by one or more signal transmitters 808.

The one or more signals 806 received by the first mobile computing device 802 can be geolocation signals. Geolocation signals can be transmitted by satellites, by base stations on Earth and/or other geolocation signal transmitters. The one or more signals 806 received by the first mobile computing device 802 can be wireless communication signals from one or more base stations. The one or more base stations can transmit short-range wireless communication signals, such as WiFi, Bluetooth, NFC and/or other short-range wireless communications. The one or more base stations can transmit longer-range wireless communication signals, such as GPRS, GSM, CDMA, and/or other longer-range wireless communication signals.

A location of the first mobile computing device 802 can be determined based on the strength and/or delay of the one or more signals 806 received from the signal transmitter 808. The location of the first mobile computing device 802 can be determined based on triangulation of signals transmitted by three or more signal transmitters 808. For short-range wireless communication signals, the location of the first mobile computing device 802 can be approximately determined based on ability of the first mobile computing device 802 to receive the signal from the short-range wireless communication base station.

The first mobile computing device 802 can include one or more sensors for facilitating the determination of location of the first mobile computing device 802.

The first mobile computing device 802 can be configured to communicate with a second mobile computing device 810. The second computing device 810 can be a mobile computing device. The second computing device 810 can communicate with the first mobile computing device 802 using wireless communication signals 812. The second computing device 810 can be configured to communicate with the first mobile computing device 802 through one or more networks 814, such as the Internet.

A service worker can be registered with a digital gratuity rendering application. The service worker can be associated with a particular service worker employer, location, and/or service provider. The service worker employer, location and/or service provider can have a known location. At 904 the location of a service worker can be identified. The service worker can register with the digital gratuity rendering application and provide details of the service worker's place of providing service. At 906, in response to identifying that first mobile computing device 802 is within a threshold distance of an employer of a service worker, the machine readable instructions 816 can be configured to cause the processor(s) to present service workers to the customer on the graphical user interface associated with the customer's mobile computing device.

At 908, the processor(s) 802 of the first mobile computing device can facilitate selection and/or entry of the service worker, by a user of the first mobile computing device 802. Selection and/or entry of the service worker can facilitate the user participating in a digital gratuity rendering process of a digital gratuity rendering application executed at least in part by the first mobile computing device 802.

At 910, a digital gratuity can be exchanged from an account associated with the first mobile computing device 802 to the service worker. The digital gratuity can have a value that can be incremented to or decremented from a gratuity account value associated with the service worker and maintained by the digital gratuity rendering application.

The system 800 can include a server 818. The server 818 can be in electronic communication with the first mobile computing device 802 and/or the second mobile computing device 810. The server 818 can host information associated with the digital gratuity rendering application. The server 818 can host information associated with balance of the digital gratuity rendering application. External resources 820 can communicate with the components of the system 800. The external resources 820 can communicate through the one or more networks 814, such as the Internet. External resources 820 can include financial institutions by which users of the system transfer funds.

The second computing device 810 can be configured to be associated with a single service worker, such that every service worker within an establishment has their own second computing device 810. In response to an indication that a service has been provided and that a particular second computing device 810 is determined to be within a threshold distance of the first mobile computing device 802 belonging to the customer that just received service, the first mobile computing device 802 can be configured to facilitate rendering of a digital gratuity to the service worker. The threshold distance can include a predetermined distance, the closest computing device to the first mobile computing device 802, and/or other factors.

In some variations, multiple service workers can be associated with a particular location and/or a particular second computing device 810. The first mobile computing device 802 can be configured to cause presentation of all service workers associated with a particular location and/or second computing device 810.

The first mobile computing device 802 can include electronic storage 826 and the second computing device 810 may include electronic storage 828. The first mobile computing device 802, the second computing device 810 and/or the server(s) 818 may include a plurality of hardware, software, and/or firmware components operating together to provide the functionality attributed herein any one of the first mobile computing device 802, the second computing device 810 and/or the server(s) 818.

The first mobile computing device 802, the second mobile computing device 810 and/or the server(s) 818 can include one or more processors configured to execute computer program instructions 816 and 822. Although the computer program instructions 816 and 822 are illustrated as being separate entities and in separate entities in FIG. 8, this is not intended to be limiting. This is for ease of explanation only. The computer program instructions 816 and 822 can be executed on any one or any multiple ones of the first mobile computing device 802, second computing device 819, server(s) 818, external resources 820 and/or other devices. By way of non-limiting example, the first mobile computing device 802 and/or the second mobile computing device 810 may include one or more of a desktop computer, a laptop computer, a handheld computer, a tablet computing platform, a NetBook, a Smartphone, a gaming console, a smartwatch, wearable computing devices and/or other computing platforms.

The first mobile computing device 802, second computing device 810 and server(s) 818 can include electronic storage 826 and 828. Electronic storage 826 and 828 can be located in one electronic storage or multiple other ones of electronic storage. Electronic storage 826 and 828 can comprise electronic storage media that electronically stores information. The electronic storage media of electronic storage 826 and 828 can include one or both of system storage that is provided integrally (i.e., substantially non-removable) with the first mobile computing device 802 and/or the second mobile computing device 810 and/or removable storage that is removably connectable to the first mobile computing device 7802 and/or the second mobile computing device 810 via, for example, a port (e.g., a USB port, a firewire port, removable SD card port, etc.) or a drive (e.g., a disk drive, etc.). Electronic storage 802 and 810 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 826 and 828 may include one or more virtual storage resources (e.g., cloud storage, a virtual private network, and/or other virtual storage resources). Electronic storage 826 and 828 may store software algorithms, information determined by processor(s) 826 and 828, information received from the first mobile computing device 802, the second mobile computing device 810 and/or the server(s) 818, and/or other information that enables the first mobile computing device 802, the second mobile computing device 810 and/or the server(s) 318 to function as described herein. The electronic storage 826 and 828 described herein can be disposed remotely, such as in server(s) 818 or on external devices in electronic communication with the first mobile computing device 802, the second mobile computing device 810 and/or the server(s) 818.

Processor(s) 804 and 824 are configured to provide information processing capabilities in the first mobile computing device 802 and the second computing device 810. As such, processor(s) 804 and 824 may include one or more of a digital processor, an analog processor, a digital circuit designed to process information, an analog circuit designed to process information, a state machine, and/or other mechanisms for electronically processing information. Although processor(s) 804 and 824 are shown in FIG. 8 as single entities, this is for illustrative purposes only. In some variations, processor(s) 804 and 824 may each include a plurality of processing units. These processing units may be physically located within the same device, or processor(s) 804 and 824 may represent processing functionality of a plurality of devices operating in coordination. The processor(s) 804 and 824 may be configured to execute computer program instructions 804 and 824. The computer program instructions 804 and 824 may cause the processor(s) 804 and 824 to perform one or more of the operations and/or features described herein. Processor(s) 804 and 824 can be configured to execute one more additional and/or alternative operations than those described herein. Processor(s) 804 and 824 can be configured to perform its functions by software; hardware; firmware; some combination of software, hardware, and/or firmware; and/or other mechanisms for configuring processing capabilities on processor(s) 804 and 824.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The variations set forth in the foregoing description do not represent all variations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the variations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other variations may be within the scope of the following claims.

What is claimed is:

1. A method comprising:
identifying, by a location based service on a first mobile computing device, a second mobile computing device associated with a service worker who renders a service;
selecting, by a processor of the first mobile computing device, the second mobile computing device for participation in a digital gratuity rendering process of a digital gratuity rendering application executed at least in part by both the first mobile computing device and the second mobile computing device;
exchanging, via the digital gratuity rendering process of the digital gratuity rendering application, a digital gratuity from the first mobile computing device to the second mobile computing device, the digital gratuity having a value that can be incremented to or decremented from a gratuity account value associated with the service worker and maintained by the digital gratuity rendering application; and
tracking, by the digital gratuity rendering application, the gratuity account value associated with the service worker based on the exchanging and the value of the digital gratuity.

2. The method in accordance with claim 1, further comprising calculating, by the digital gratuity rendering application, a broker fee upon the exchanging of the digital gratuity.

3. The method in accordance with claim 1, wherein the digital gratuity is a digital expression of the customer's satisfaction with the service rendered by the service worker.

4. The method in accordance with claim 1, wherein the digital gratuity rendered to the service worker is tracked by the digital gratuity rendering application.

5. The method in accordance with claim 1, wherein the digital gratuity rendering application is configured to facilitate presentation of the digital gratuity rendered by the customer on a graphical user interface associated with the service worker.

6. The method in accordance with claim 5, wherein the digital gratuity rendering application is configured to facilitate presentation of the digital gratuity rendered by the customer to an employer of the service worker.

7. The method in accordance with claim 5, wherein the digital gratuity rendering application is configured to facilitate presentation of one or more service worker metrics to the employer of the service worker.

8. A system comprising:
a communication device associated with a geographical area and at least one service worker; and,
a mobile computing device associated with a customer of the at least one service worker, the mobile device having at least one receiver configured to receive signals associated with the communication device;
at least one programmable physical processor configured to:
determine a location of the at least one service worker relative to the mobile computing device based on the signals associated with the communication device received at the mobile device;
determine whether the at least one service worker is within a predefined threshold distance from the mobile device;
if the at least one service worker is determined to be within a predefined threshold distance from the mobile device, provide an indication to the customer on a graphical user interface associated with the mobile computing device; and,
facilitate entry and/or selection by the customer of a digital gratuity to the at least one service worker.

9. The system as in claim 8, wherein determining a location of the at least one service worker relative to the mobile computing device includes:
receiving, at the mobile computing device, geo-location information of the of the mobile computing device;
receiving, at the mobile computing device, geo-location information of the communication device associated with the service worker; and,
determining, at the mobile computing device, the relative distance between the communication device associated with the service worker and the mobile device based on the geo-location information of the mobile device and the communication device.

10. The system as in claim 8, wherein the predefined threshold includes being proximate to a place of business of the service worker.

11. The system as in claim 8, wherein the predefined threshold is based service worker being closer to the mobile device than other service workers.

12. The system as in claim 8, wherein the digital gratuity selected and/or entered by the customer for the service worker is tracked.

13. The system as in claim 12, wherein the at least one programmable physical processor is configured to:
facilitate presentation of the digital gratuities selection and/or entered by the customer to the service worker, the presentation provided on a graphical user interface associated with the service worker.

14. The system as in claim 12, wherein the at least one programmable physical processor is configured to:
facilitate presentation of the digital gratuities selected and/or entered by the customer to the service worker, the presentation provided on a graphical user interface associated with an employer of the service worker.

15. A method comprising:
determining, by a location based service on a first mobile computing device a location of the first mobile computing device;
identifying, based on the determined location of the first mobile computing device, a service worker associated with the determined location;
providing, on a screen of the first mobile computing device, an indication of the service worker associated with the determined location;
facilitating, by a processor of the first mobile computing device, selection and/or entry of the service worker, by a user of the first mobile computing device, for participation in a digital gratuity rendering process of a digital gratuity rendering application executed at least in part by the first mobile computing device;
exchanging, via the digital gratuity rendering process of the digital gratuity rendering application, a digital gratuity from the first mobile computing device to the service worker, the digital gratuity having a value that can be incremented to or decremented from a gratuity account value associated with the service worker and maintained by the digital gratuity rendering application.

16. The method as in claim 15, wherein the digital gratuity rendering application facilitates creation of a digital gratuity account by a service worker through an Internet server and the method further comprises:
receiving, by a processor of the Internet server, location information associated with the service worker.

17. The method as in claim 15, wherein the location based service of the first mobile computing device includes a receiver configured to receive one or more geo-location signals.

18. The method in accordance with claim 15, wherein the digital gratuity has an associated intrinsic value.

19. The method in accordance with claim 15, wherein the digital gratuity rendered to the service worker is tracked by the digital gratuity rendering application.

20. The method in accordance with claim 15, wherein the digital gratuity rendering application is configured to facilitate presentation of the digital gratuity rendered by the customer on a graphical user interface associated with the service worker.

21. The method in accordance with claim 15, wherein the digital gratuity rendering application is configured to facilitate presentation of the digital gratuity rendered by the customer to an employer of the service worker.

22. The method in accordance with claim 15, wherein the digital gratuity rendering application is configured to facilitate presentation of one or more service worker metrics to the employer of the service worker.
